(19) United States
(12) Patent Application Publication
(10) Pub. No.: US 2024/0176927 A1
(43) Pub. Date: May 30, 2024

(54) METHOD FOR MODELING A SENSOR IN A TEST ENVIRONMENT

(71) Applicant: SICK AG, Waldkirch (DE)

(72) Inventors: Steffen WITTMEIER, Waldkirch (DE); Dominic RUH, Freiburg (DE)

(21) Appl. No.: 18/512,156

(22) Filed: Nov. 17, 2023

(30) Foreign Application Priority Data
Nov. 18, 2022 (EP) 22208244.8

(51) Int. Cl. G06F 30/20; G01S 17/32

(52) U.S. Cl. CPC G06F 30/20; G01S 17/32

(57) ABSTRACT

A method for modeling a sensor\ for measuring a distance in a virtual test environment include: defining a simulation model, wherein the simulation model includes a virtual sensor and the virtual test environment, and a virtual transmission signal sent by the virtual sensor is simulated in the virtual test environment; it is determined whether the virtual transmission signal impacts a virtual object at a point of impact in the virtual test environment; in the event of a positive determination, a distance of the virtual transmission signal covered by the virtual sensor up to the point of impact is calculated in the virtual test environment; and at least one output value of the virtual sensor is determined, wherein the determination of the output value takes place based on at least one parameter of the simulation model, wherein the parameter and/or the output value is/are modeled by a probabilistic distribution.

The invention relates to a method for modeling a sensor, in particular an FMCW LiDAR sensor, in a virtual test environment, in particular for the preliminary development and/or testing of algorithms or software in an industrial environment and/or in particular for the testing of software for mobile robots and/or for fork-lift trucks.

Currently, the development of high-performance, highly integrated sensor technologies, such as FMCW LiDAR sensors or imaging RADAR sensors, is being driven forward. The use of such sensors is of decisive importance for a large number of applications, in particular with respect to mobile robots and/or fork-lift trucks. Accordingly, new sensor technologies and their performance in the corresponding applications must be tested before commercial use. In WO2021004626A1, a method for simulating CW LiDAR sensors is described, in which a complex and elaborate simulation of the measurement principle is performed to realistically replicate the mode of operation of a real CW LiDAR sensor.

A disadvantage of this method is that a large amount of sensor-specific information is required to simulate the actual mode of operation of the CW LiDAR sensor. Furthermore, the simulation of the CW-LiDAR sensor at this abstraction level is very costly and computationally intensive.

Thus, it is an underlying object of the invention to provide an improved method for examining (new) sensors in the context of already existing or new applications as well as a corresponding system.

This object is satisfied by a method according to claim 1 and by a system according to claim 15.

The invention relates to a method for modeling a sensor, in particular an FMCW LiDAR sensor for distance measurement in a virtual test environment, in particular for testing software for mobile robots and/or for fork-lift trucks, wherein:

a simulation model is defined, wherein the simulation model comprises a virtual sensor and the virtual test environment, wherein in the method:
a virtual transmission signal sent by the virtual sensor is simulated in the virtual test environment, in particular by means of ray tracing;
it is determined whether the virtual transmission signal impacts a virtual object at a point of impact in the virtual test environment;
in the event of a positive determination, a distance of the virtual transmission signal covered by the virtual sensor up to the point of impact is calculated in the virtual test environment; and
at least one output value of the virtual sensor is determined based on the calculated distance,
   wherein the determination of the output value further takes place based on at least one parameter of the simulation model, wherein the parameter and/or the output value is/are modeled by a probabilistic distribution.

In other words, a sensor is simulated in a virtual world, in particular a two-dimensional or three-dimensional world, to generate simulated sensor data, i.e. output values, that result from the detection of the virtual world by the virtual sensor. In accordance with the invention, at least one parameter of the simulation model and/or the output value is/are in this respect modeled by a probabilistic distribution, i.e. modified by a probability distribution. By applying the probabilistic distribution to the parameter and/or the output value, a certain “variability” is provided for the output value, whereby the fluctuations of e.g. measurement values of a real sensor in real operation can be replicated.

The virtual transmission signal is in particular an abstraction of an electromagnetic wave. For example, the virtual transmission signal can be a virtual light beam or a virtual transmission pulse. Alternatively, sound signals, are however, also possible, for example. The simulated sensor can therefore e.g. be an optical sensor (such as the Frequency-Modulated Continuous Wave Light Detection and Ranging (FMCW-LiDAR) sensor mentioned above), a radar sensor, or an ultrasonic sensor.

By applying the probabilistic distribution, the advantage is in this respect achieved that very many physical effects (e.g. the exact reflection characteristics of the transmission signal transmitted by the sensor at non-homogeneous surfaces or the behavior of the transmission signal in rain) do not have to be simulated since these effects can be cumulatively included in the probabilistic distribution. In this respect, the probabilistic distribution can be applied to the parameter and/or the output value with considerably less computational effort, whereby a significant saving of computing power and/or computing time is achieved.

As already described, the simulated virtual transmission signal is in particular simulated in the simulation model by means of a ray tracing method in which the path of the virtual transmission signals, in particular only, from the virtual sensor or a starting point up to the point of impact of the virtual transmission signal on the object is considered.

Furthermore, a reflection of the virtual transmission signal at the point of impact can be simulated in the same way. Here, starting from the point of impact, a further virtual transmission signal is transmitted that is simulated up to a further point of impact. This can take place recursively and any number of reflections can thus be considered.

Furthermore, to simulate multi-echo effects, a plurality of points of impact can be considered along a virtual transmission signal in the virtual test environment, starting from the sensor or a starting point. For example, a virtual transmission signal can have a plurality of points of impact along its beam direction, on different virtual objects in each case. For each point of impact, the distance covered can then be calculated, wherein, for each point of impact, an output value of the virtual sensor is calculated based on the distance, wherein the determination of the respective output value further takes place based on at least one parameter of the simulation model, wherein the parameter and/or the output value is/are modeled by a probabilistic distribution. Effects such as those that e.g. occur with transparent materials can hereby be considered when calculating the output values. For example, a point of impact on a glass pane and simultaneously a point of impact on an object disposed behind it can be simulated.

The return path of such virtual transmission signals after impacting a virtual object is in particular not considered or determined. Rather, a comprehensive simulation of such virtual transmission signals, in particular of the behavior of the virtual transmission signals after impacting the virtual object, is omitted so that computational effort is saved and the simulation is further accelerated. In the simulation, it is assumed that a transmission signal that impacts an object also returns to the sensor. However, possible attenuations or interferences of the returning transmission signal are preferably not simulated, but modeled in a general manner by the probabilistic distribution or introduced into the output value.

The simulation of sensor parameters such as the simulation of an electromagnetic wave with the corresponding properties, such as the modulation of the wavelength, is preferably omitted. In other words, the simulation model is generated, in particular only, based on top-level information, such as the beam direction of the virtual transmission signal and the point of impact. As already mentioned above, the virtual transmission signal is thus simulated in a simplified manner. The simulation model can inter alia comprise a sensor model that e.g. maps physical parameters of a real sensor in the simulation model, for example a rotation of a mirror in the case of a laser scanner. The angle of rotation of the mirror can thereby become a parameter of the simulation model.

If the point of impact of the virtual transmission signal is known, the distance of the sensor from the point of impact can, based on the information about the position of the point of impact and the position of the sensor, be calculated based on the corresponding coordinates, for example. It is, for example, possible to determine a position vector from the sensor to the point of impact, the length of said position vector representing the distance between the virtual sensor and the point of impact or the virtual object. It is understood that the distance covered does not necessarily have to be explicitly calculated; implicit determinations of the distance covered are also possible.

As already indicated above, in the real world, when determining the distance from an object or a point of impact of an object, i.e. when a real distance sensor detects a distance from a real object, a plurality of further factors, in particular external factors, usually play a role, some of which have already been mentioned above. The properties of the light emitted, the weather conditions, or the reflective properties of the material of the objects are just a few of many such factors. Since the consideration of such factors in the simulation increases the computational effort, such factors are preferably not included in the simulation model in accordance with the invention when determining the output value of the virtual sensor.

Rather, one or more parameters of the simulation model in accordance with the invention and/or one or more output values of the virtual sensor are modeled by a probabilistic distribution that indirectly models the influence of the aforementioned factors on the output value of the virtual sensor. Accordingly, a simulation of the abovementioned factors is not necessary. Rather, due to the use of the probabilistic distribution, the computational effort for the simulation model is reduced and the most accurate and realistic simulation model possible is simultaneously provided. The parameters of the simulation model can comprise all the parameters that are used when calculating the output values. For example, the parameters of the simulation model can comprise properties of the virtual transmission signal and/or properties of the virtual object, e.g. its shape, size, and/or position.

In accordance with the invention, the determination of the output value further takes place based on at least one parameter of the simulation model, wherein the parameter and/or the output value is/are modeled by a probabilistic distribution. In this respect, the output value can (at least approximately) correspond to a measurement value which a real sensor would have output in the simulated situation. The output value can e.g. be a distance value, a velocity vector, a speed value, e.g. a radial speed value, an intensity value, and/or the like.

A plurality of different output values can in particular be output based on the probabilistic distribution of the output value. For example, output values can, in particular randomly or weighted according to their probability distribution, be selected from the probabilistic distribution whose probability of occurrence assigned by the probabilistic distribution is preferably higher than a predefined threshold value. The various output values can in particular be output successively or jointly, depending on the application.

In addition to the advantages already mentioned above, the invention has the further advantage that the simulation of the sensor reduces the effort for generating sensor data and a large amount of data can thus be generated in a short time. Consequently, the effort and the time for testing algorithms or applications that are operated using the sensor data are also reduced. Furthermore, the virtual test environment can be changed as desired and a plurality of different and special scenarios can be simulated so that the sensor data can map a versatile spectrum of scenarios, in particular in the industrial environment, for example in the operation of mobile robots and/or fork-lift trucks.

Further embodiments of the invention can be seen from the description, from the dependent claims, and from the drawings.

In accordance with a first embodiment, noise is generated in the output value by the probabilistic distribution. More precisely, the noise causes the output value to fluctuate (e.g. when outputting a plurality of temporally spaced output values). This noise therefore simulates the effects in the real world that would lead to fluctuations in real measurement values.

The probabilistic distribution can therefore represent mechanical inaccuracies of the (real) sensor (e.g. angular noise of a beam deflection), measurement inaccuracies of the (real) sensor (e.g. distance noise or measurement noise in general) and the like.

In accordance with a further embodiment, the probabilistic distribution comprises a normal distribution. The modeling of a parameter can thus, for example, take place by defining an expected value and a value for the standard deviation. A value that is assumed to be an ideal value or a reference value can be used as the expected value. In the case of a virtual transmission signal, an ideal direction or reference direction of the normal distribution can be taken as a basis for the expected value, as explained above. In the case of a normally distributed distance value, a distance value determined by the simulation model can, for example, be used as the expected value. The same applies accordingly to the determined radial speed. The standard deviation of the normal distribution can in this respect determine the degree of noise. The standard deviation can, for example, be defined in advance on a sensor-specific basis or can itself be a function of further simulation parameters, such as the distance value or the reflectance value of the impacted object.

As an alternative to the normal distribution, a logarithmic normal distribution, an exponential distribution or another probability distribution can also be used, for example.

In accordance with a further embodiment, the output value comprises a determined distance value from the virtual object or from the point of impact of the virtual transmission signal on the virtual object and/or a determined radial speed of the point of impact of the virtual transmission signal on the virtual object with respect to the virtual sensor. The output value can, for example, be a value comparable to a measurement value of a real sensor. The determined distance value and/or the determined radial speed is/are in particular modeled by the probabilistic distribution. The determined (ideal) distance value and/or the determined (ideal) radial speed are thus subjected to a noise to consider an inaccuracy of the output value. The determined distance value and/or the determined radial speed can, for example, be determined by a calculation using the point of impact of the virtual transmission signal on the virtual object. In particular, only geometric data from the test environment can be used for the calculation.

In accordance with a further embodiment, the parameter comprises an azimuth angle of the virtual transmission signal and/or an elevation angle of the virtual transmission signal.

In accordance with a further embodiment, the virtual transmission signal is simulated, in particular only, based on the azimuth angle, the elevation angle and a starting point of the virtual transmission signal.

For example, the azimuth angle and the elevation angle of the virtual transmission signal together with the starting point indicate a beam direction, in particular a unique beam direction, of the virtual transmission signal. For example, the starting point defines a unique point in the virtual test environment starting from which the virtual transmission signal is sent. For example, the starting point can overlap with a position of the virtual sensor. The azimuth angle or horizontal angle indicates the angle of the virtual transmission signal with respect to a reference direction in a horizontal plane, while the elevation angle or vertical angle describes the angle of the virtual transmission signal with respect to a reference direction in a vertical plane.

The azimuth angle and/or elevation angle can in particular be modeled by a probabilistic distribution. For example, due to the probabilistic distribution of the azimuth and/or elevation angle, a deviation of the virtual transmission signal from an intended beam direction, i.e. from a reference beam direction that can comprise a reference azimuth angle and/or a reference elevation angle, can be achieved. This deviation can e.g. correspond to the mechanical inaccuracy when a real sensor transmits a transmission signal.

For example, the probabilistic distribution of the azimuth angle and/or elevation angle can be determined based on the reference beam direction by taking the reference beam direction or the reference azimuth angle and/or the reference elevation angle of the probabilistic distribution as a basis for the expected value(s).

The probabilistic distribution of the azimuth angle and/or elevation angle can preferably be included in the calculation of the output value. For this purpose, after changing the azimuth angle and/or the elevation angle, the point of impact of the virtual transmission signal for the changed angles can be determined. The calculated distance can thereby e.g. be different than in the case of unchanged angles. Data tuples that comprise a changed azimuth angle compared to the reference azimuth angle and a changed elevation angle compared to the reference elevation angle are in particular successively generated based on the probabilistic distribution of the azimuth angle and elevation angle to calculate corresponding points of impact in the virtual test environment. In this way, the probabilistic distribution is included in the output value.

In accordance with a further embodiment, based on the probabilistic distribution of the parameter and/or the output value, a plurality of random values for the parameter and/or the output value are successively generated that are used for the determination of the output value, wherein a random value is generated depending on a previously generated random value. The generation of the random values can take place based on predefined or specified rules, for example, by introducing additive conditional probability distributions. An additive conditional probability distribution is, for example, characterized by the probability distribution of one random variable being dependent on the probability distribution of another random variable. In particular, the probability distribution of the random variable “Generate a random value at a point in time t” can be dependent on the probability distribution of the random variable “Generate a random value at a point in time t-1”. The generation of a random value can therefore take place in dependence on a previously generated random value. For example, the previously described data tuples can be successively generated, wherein the generation can take place based on predefined rules. The predefined rules can in particular consider or map a movement of the virtual sensor. It hereby, for example, becomes possible to model the time-dependent deflection angle or jitter of a scanner mirror or the oscillation of the sensor or of a holder of the scanner due to environmental influences such as wind. Furthermore, the real time course of such parameters can be identified by experiments and can be used directly in the simulation.

In accordance with a further embodiment, the calculation of the distance of the virtual transmission signal covered by the virtual sensor up to the point of impact on the virtual object in the virtual test environment further comprises that:
the azimuth angle and elevation angle of the virtual transmission signal are modeled as an expected value by a probabilistic distribution with a predefined reference azimuth angle and a predefined reference elevation angle;
a plurality of different virtual auxiliary transmission signals, whose azimuth angle and elevation angle differ from the reference azimuth angle and reference elevation angle, are selected based on the probabilistic distribution of the virtual transmission signal;
for each virtual auxiliary transmission signal, it is determined whether the virtual auxiliary transmission signal impacts the virtual object at a point of impact and/or impacts at least one further virtual object at at least one further point of impact; in the event of a positive determination, a distance of the virtual auxiliary transmission signal covered by the virtual sensor up to the point of impact is calculated in the virtual test environment; and
a final distance value is determined based on the plurality of calculated distance values.

In other words, a plurality of additional virtual auxiliary transmission signals are generated using the probabilistic distribution of the azimuth angle and elevation angle of the virtual transmission signal. In particular, a number N, for example 10, 50, 100 or 200, of virtual auxiliary transmission signals are generated. Due to the probabilistic distribution, the virtual auxiliary transmission signals are transmitted in different directions. In this respect, the distances covered by these auxiliary transmission signals from the starting point up to the point of impact on the virtual object or at least one further point of impact on at least one further virtual object are calculated and included in the calculation of the final distance value, as will be explained in more detail below. Due to the different directions of the auxiliary transmission signals, the distance values usually also differ; different virtual objects can in particular be impacted.

In accordance with a further embodiment, the final distance value is determined in that:
a predefined number of bins of the same size is initialized for a predefined distance range, with each bin being assigned to a different subrange within the predefined distance range;
for each auxiliary transmission signal, it is determined whether the corresponding virtual transmission signal has a respective point of impact with the virtual object and/or the at least one further virtual object in the virtual test environment, in particular in the predefined distance range, and in the event of a positive determination, an associated distance value is determined from the starting point to the respective point of impact, wherein each distance value is assigned to a corresponding bin;
an average distance value is calculated based on the distance values that are associated with the bin that has the highest number of assigned distance values;
the final distance value is modeled by means of a probabilistic distribution based on the average distance value and is defined as the output value.

In other words, a predefined distance range is defined, for example, a specific measurement range of the sensor that can be defined by a minimum distance value and a maximum distance value, wherein the predefined distance range is divided into different bins. In this respect, each bin, for example, represents a subrange within the predefined distance range and can be defined by a minimum and maximum distance value. Subsequently, each determined distance value is assigned to a bin by determining whether the determined distance value of the corresponding auxiliary transmission signal lies in the subrange of the corresponding bin. Determined distance values that cannot be assigned to a bin can be disregarded, for example. After the assignment of the determined distance values is completed, the bin with the most assigned distance values is, for example, selected and the distance values assigned to this bin are averaged to obtain the average distance value. The final distance value can then be modeled by means of a probabilistic distribution based on the average distance value and can be output as an output value.

For example, the average distance value can be used as the expected value and the standard deviation of the probabilistic distribution can be determined based on the distance values determined starting from the auxiliary transmission signals.

For example, an index i of the bin, with which a calculated distance value d_{ray} of an auxiliary transmission signal is associated, is calculated as follows:

$$i = \frac{{d}_{r a y} - {d}_{min}}{{d}_{max} - {d}_{min}} \times ( k - 1 )$$

where i represents the index of the bin to which the calculated distance value d_{ray} is assigned, dₘᵢₙ and dₘₐₓ represent a minimum distance and a maximum distance of the predefined distance range, and k represents the predefined number of bins. For example, the predefined distance range can be between 20 and 30 m, 40 m and 50 m, 70 and 100 m, or 130 and 150 m. Furthermore, the number k of bins can be defined arbitrarily. For example, the number of bins can be 8, 16, 32, 64, 128, 256, 512, 1024, or 2048.

In accordance with a further embodiment, the determination of the radial speed of the point of impact of the virtual transmission signal on the virtual object with respect to the virtual sensor comprises that:
a point of impact i of the virtual transmission signal on the virtual object is determined at a point in time t, wherein the position of the point of impact vₕᵢₜ(t) on the virtual object is determined in the three-dimensional virtual test environment;
at a point in time t+Δt, the current position of the point of impact vₕᵢₜ(t+Δt) on the virtual object (30) is determined in the three-dimensional virtual test environment (4); and
at a point in time t+Δt, the three-dimensional velocity vector of the point of impact is determined based on the two temporally consecutive positions of the point of impact vₕᵢₜ(t) and vₕᵢₜ(t+Δt) and, by projection in the direction of the transmitted virtual transmission signal, the radial speed of the point of impact is determined with respect to the sensor in the virtual test environment at the point in time t.

In particular, for the determination of the point of impact, a grid or mesh is formed that, for example, has a plurality of triangles, rectangles and/or another geometric shape. The virtual object can in particular be represented or simplified by an appropriate grid. The grid can in particular be defined by the coordinates of the corner points of the grid. Furthermore, the position of the point of impact within the grid, in particular with reference to corner points of the grid, can be determined and stored.

To determine the speed of the point of impact now, the position of the point of impact is determined at a point in time t and at a point in time t+Δt so that a first position, in particular a first impact vector, and a second position, in particular a second impact vector, of the point of impact are determined. Based on the determined first and second position, a distance between the first and second position can be determined, wherein, based on the distance between the first and second position and the time Δt required for covering the corresponding distance, the speed of the point of impact of the virtual transmission signal on the virtual object can be determined in the virtual test environment. Furthermore, based on the determined speed of the point of impact and the calculated position of the point of impact at a point in time t, the radial speed of the point of impact can be determined with respect to the sensor. For example, the velocity vector of the point of impact can be projected in the direction of the first virtual transmission signal to determine the radial speed of the point of impact with respect to the sensor.

It is particularly advantageous here that the determination of the radial speed takes place by simulating a virtual transmission signal, in particular a single virtual transmission signal, in that the point of impact on the virtual object and in particular within the grid is noted or stored at a point in time t and the coordinates of the point of impact within the grid are determined or queried at a point in time t+Δt. Consequently, a complex simulation of a second transmission signal, which can only be implemented with difficulty or in a computationally intensive manner due to the high temporal resolution required, can be omitted.

In accordance with a further embodiment, a validity of the output value is determined based on a distance-dependent probability. For example, the expected value of a Bernoulli distribution is selected in dependence on the distance and thus the validity of the determined distance value and/or of the determined radial speed is determined.

Furthermore, distance values in a validity range, i.e. a valid distance range [rₘᵢₙ, rₘₐₓ], can, for example, be defined as valid values, whereas distance values outside the validity range are, in contrast, discarded or disregarded as invalid values. The validity range can, for example, be defined in a sensor-specific manner and/or based on properties attributed to the virtual objects.

In accordance with a further embodiment, physical sensor data and/or physical position data of a real sensor are evaluated to create the virtual test environment. Thus, information about the sensor and/or its installation location, e.g. measured at a real sensor or e.g. taken from data sheets or similar, can be included in the design of the virtual test environment. In this way, the possibility of simulating a real situation in the virtual test environment is created.

In accordance with a further embodiment, information obtained in the virtual test environment, in particular the output values, is used to configure a or the real sensor for real operation. For this purpose, the real sensor can e.g. be coupled to a simulation device via a data link in order to transfer settings or parameters to the real sensor.

It can e.g. become apparent in the virtual test environment that certain settings of the sensor are advantageous for the simulated application. These settings can e.g. relate to a specific scan pattern (i.e. the pattern of the transmission of transmission signals), advantageous scan frequencies (i.e. the temporal frequency of the transmission of transmission signals), the transmission power, but also the exact positioning and/or orientation of the sensor, and the like.

For example, the virtual sensor is therefore arranged in the virtual test environment, wherein, after the simulation, a real sensor is set based on data of the virtual sensor. Due to the simulation of the virtual sensor in the virtual test environment, different positions of the virtual sensor can preferably be tested and an advantageous positioning of the virtual sensor can be determined. The real sensor can thus be positioned in accordance with the position of the virtual sensor and can be initialized or calibrated with the position data of the virtual sensor.

In accordance with a further embodiment, annotation data, for example metadata or data on virtual objects in the virtual test environment, are generated based on data of the virtual test environment and/or data of the virtual sensor. For example, the annotation data can also comprise 3D bounding boxes for objects within point clouds. It is particularly advantageous here that the generation of the annotation data is not associated with an additional computational effort since corresponding annotation data are already provided by the test environment. The annotation data can, for example, indicate whether an object impacted by the virtual transmission signal is e.g. a human, a vehicle, the ground, or a building.

In accordance with a further embodiment, AI models for mobile robots and/or for fork-lift trucks are trained by means of the data generated by the simulation model and/or the annotation data. For example, the AI models can be trained online, i.e. by data generated in real time, and/or offline, i.e. by already existing data or data generated in the past. When training an AI model, it can be of particular advantage if annotation data are available since it can then also be checked whether the AI model correctly recognizes a human as such, for example.

In accordance with a further embodiment, a plurality of virtual transmission signals transmitted up to a predefined measurement time are jointly processed. A snapshot of a current scene in the virtual test environment is thus generated.

In accordance with a further embodiment, a plurality of virtual transmission signals transmitted up to a predefined measurement time are divided into a predefined number of subsets that each correspond to an equal time duration, wherein the virtual transmission signals belonging to a subset are jointly processed. Thus, a current scene of the virtual test environment is scanned.

A further object of the invention is a system for modeling a sensor, in particular an FMCW LiDAR sensor, in a virtual test environment, in particular for testing software for mobile robots and/or for fork-lift trucks, comprising a simulation device that is configured:
to define a simulation model, wherein the simulation model comprises a virtual sensor and the virtual test environment;
to simulate a virtual transmission signal sent by the virtual sensor in the virtual test environment;
to determine whether the virtual transmission signal impacts a virtual object at a point of impact in the virtual test environment;
in the event of a positive determination, to calculate a distance of the virtual transmission signal covered by the virtual sensor up to the point of impact on the virtual object in the virtual test environment; and
to determine at least one output value of the virtual sensor based on the calculated distance,
   wherein the determination of the output value further takes place based on at least one parameter of the simulation model, wherein the parameter and/or the output value is/are modeled by a probabilistic distribution.

The system can in particular be used to monitor vehicles and pedestrians, for example in urban areas, to detect containers, to detect production environments, in particular (mobile) robots, automated guided vehicles, factory automation, or logistics.

In accordance with a further embodiment, ray tracing-specific hardware is used for the simulation of the virtual transmission signals (for example a graphics card) and/or the virtual test environment is simulated by means of a game engine. Advantageously, the simulation can thereby be accelerated.

The statements regarding the method in accordance with the invention accordingly apply to the system; this in particular applies with respect to advantages and embodiments.

Furthermore, if not otherwise stated, any combination of the preceding embodiments is possible.

The invention will be presented purely by way of example with reference to the drawings in the following. There are shown:

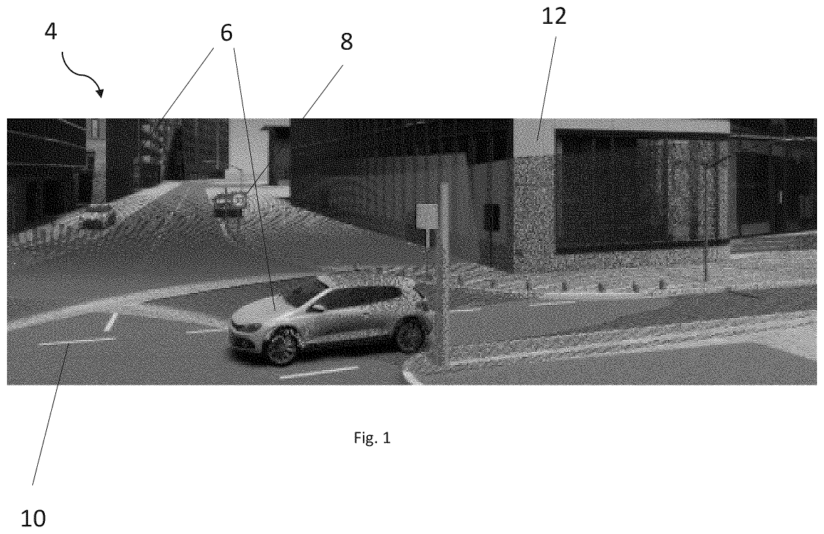

FIG. 1 a virtual test environment;

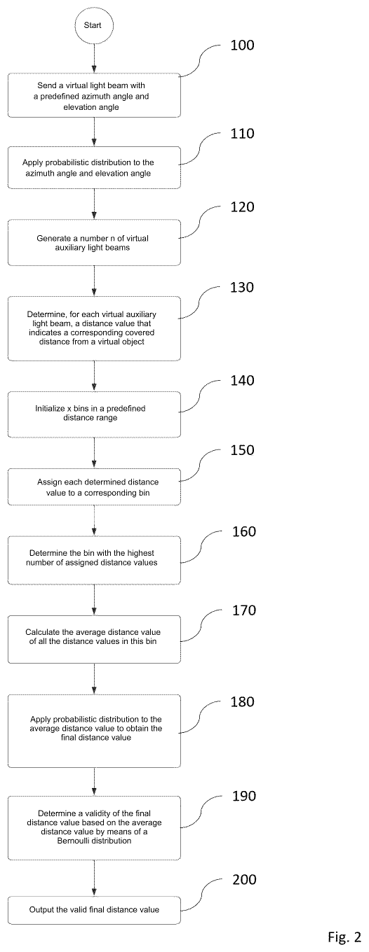

FIG. 2 a method for modeling a sensor in the virtual test environment;

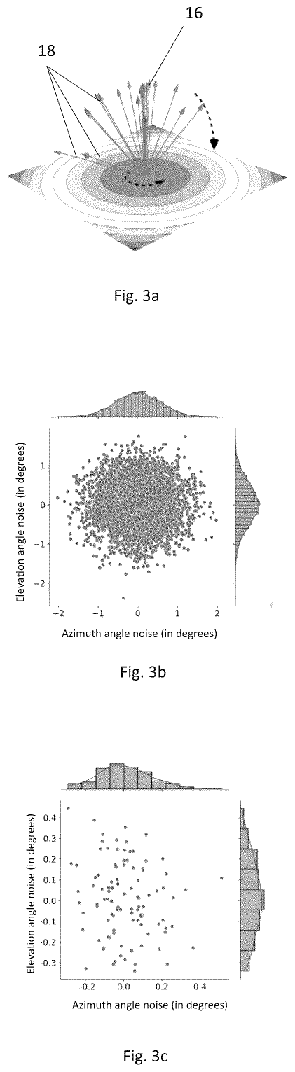

FIG. 3a a set of virtual light beams comprising a reference light beam and a plurality of auxiliary light beams;

FIG. 3b a diagram of the azimuth and elevation angle noise for a standard deviation of σ_{Azimuth}=0.326° and σ_{Elevations}=0.275° with 5000 data points;

FIG. 3c a diagram of the azimuth and elevation angle noise for a standard deviation of σ_{Azimuth}=0.326° and σ_{Elevations}=0.275° with 100 data points;

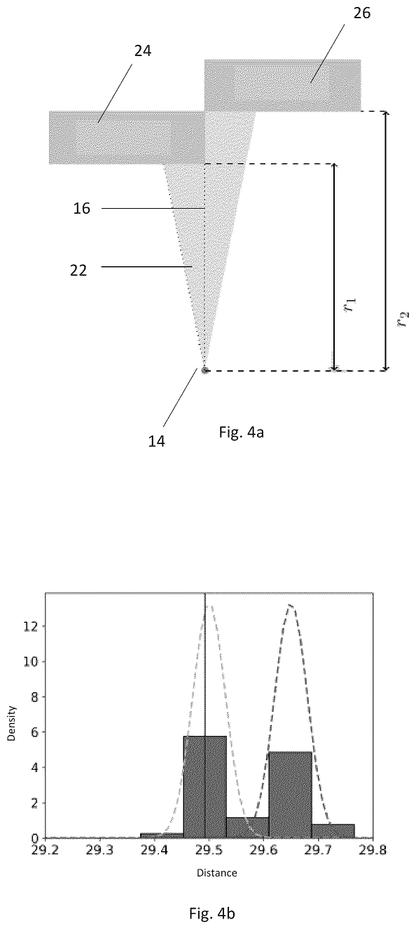

FIG. 4a a two-dimensional view of a virtual light beam cone in the virtual test environment with two virtual objects;

FIG. 4b a histogram of determined distance values in a predefined distance range;

FIG. 5 a movement of a virtual object in the virtual test environment; and

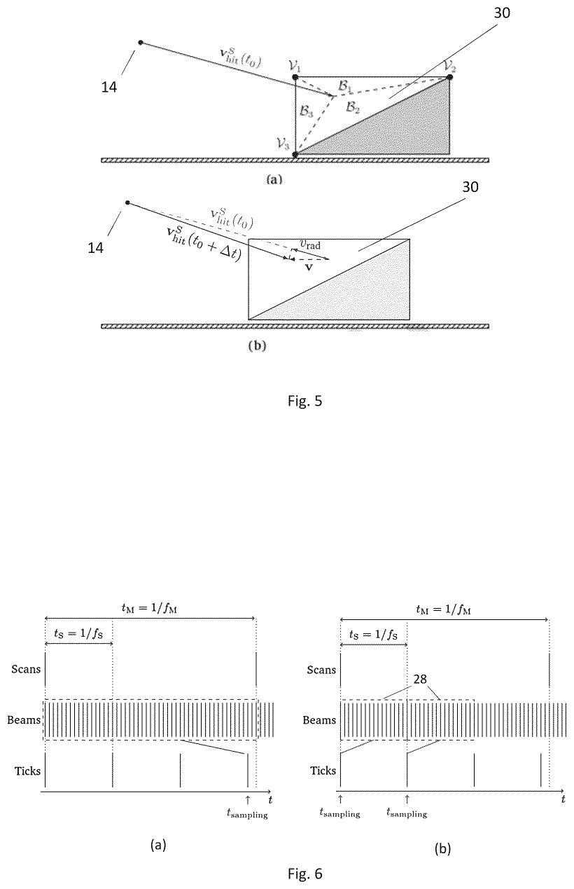

FIG. 6 an illustration of two data processing variants.

FIG. 1 shows an exemplary virtual test environment 4, i.e. a virtual three-dimensional world, that is detected by means of a virtual sensor, which is not shown and which is part of the virtual test environment, in accordance with the method shown in FIG. 2, wherein the virtual test environment 4 comprises a plurality of virtual objects such as virtual vehicles 6, virtual road infrastructure, road signs 8, road markings 10, pedestrian paths, and virtual buildings 12. The virtual test environment 4 can generally comprise all the possible objects, in particular objects other than those shown here, for example, people, animals, etc. The test environment in particular reproduces a realistic driving scenario of the real world and can be adapted as desired. The test environment is simulated on a computer (not shown) of a simulation device.

FIG. 2 shows a method 2 for modeling a sensor in the virtual test environment 4, wherein a simulation model is defined in the method 2, wherein the simulation model comprises a virtual sensor, in particular a virtual distance sensor, and the virtual test environment 4. The virtual distance sensor is in particular arranged in the virtual test environment 4. The virtual test environment 4 is a virtual three-dimensional world that has a virtual road infrastructure, i.e. virtual roads, road signs 8, road markings 10, etc., and virtual objects such as virtual people, animals, vehicles, buildings, etc.

The method starts in the method step 100 by sending a virtual transmission signal in the form of a virtual light beam from the virtual distance sensor into the virtual test environment 4 in which a virtual object is located, wherein the virtual light beam has a predefined reference azimuth angle and reference elevation angle and a starting point 14 that is, for example, defined by the position of the virtual sensor in the virtual test environment. Since the beam direction of a transmitted light beam in the real world can deviate from the intended beam direction due to interfering factors, the azimuth angle and the elevation angle of the virtual light beam are modeled with a normal distribution that simulates the influence of such interfering factors (method step 110). In other words, the beam direction of the virtual light beam is provided with a noise component. The reference azimuth angle and the reference elevation angle of the virtual light beam in this respect serve as the expected value of the normal distribution, with the standard deviation predefined by the sensor type.

Based on the normal distribution of the azimuth angle and the elevation angle, in the method step 120, a number n, in the present case 100, of virtual auxiliary light beams 18 (see FIG. 3a) are generated that start from the same starting point 14 (see FIG. 4a) and each have an azimuth angle and/or elevation angle that follows the statistics of a beam profile. Using a normal distribution, a Gaussian beam can be simulated. Using other probability distributions of the auxiliary light beams, any desired beam profiles can be modeled. In the method step 130, a distance value is then calculated for each virtual auxiliary light beam 18 and indicates a corresponding distance from the virtual object or a point of impact on the virtual object. Consequently, 100 distance values are calculated in this way. The calculation of the distance values takes place by means of ray tracing, i.e. by tracking a virtual auxiliary light beam 18 along its beam direction, wherein it is determined whether the virtual auxiliary light beam 18 impacts a virtual object along its beam direction. This is shown in more detail in FIG. 4a.

In the event of a positive determination, the point of impact is calculated based on the available information of the test environment, i.e., for example, the Cartesian space coordinates. For example, the point of intersection of the virtual light beam, i.e. the half line that is defined by the starting point 14 and a respective azimuth and elevation angle, with the virtual object, i.e. the coordinates of the virtual object, and in particular with the point of impact on the virtual object, is calculated.

After calculating the distance values associated with the auxiliary light beams 18, a number of x bins is initialized in a predefined distance range (method step 140), i.e. the predefined distance range is divided into x equidistant subranges.

Subsequently, in the method step 150, each of the 100 determined distance values is assigned to a corresponding bin in whose partial distance range the determined distance value lies. Determined distance values that cannot be assigned to a bin are disregarded in the further calculation. This results in a histogram of the determined distance values that indicates a distribution of the determined distance values. Once all 100 determined distance values have been processed to a corresponding bin, the bin with the highest number of assigned distance values is determined in the method step 160 and an average distance value of all the determined distance values that were assigned to this bin is calculated (method step 170). This average distance value thus indicates the most probable distance value and is used as the expected value to determine a normally distributed final distance value (method step 180). The standard deviation of this normal distribution is specified in advance or calculated based on the previously determined distance values.

Furthermore, in method step 190, the validity of the average distance value is determined using a Bernoulli distribution.

If the validity check reveals that the average distance value is valid, the final normally distributed distance value will be output (method step 200). In all other cases, no output value will be output.

FIG. 3a illustrates a reference light beam 16 starting from a starting point 14 and a plurality of auxiliary light beams 18 starting from the starting point 14 and having different azimuth and/or elevation angles, wherein the different light beams 16, 18 are shown as arrows and wherein the azimuth and/or elevation angle of the different auxiliary light beams 18 follows a normal distribution. The auxiliary light beams 18 shown in FIG. 3a have been generated by adding the azimuth angle of the reference light beam 16 and the elevation angle of the reference light beam 16 with random values of a normally distributed noise function.

FIG. 3b shows a diagram of azimuth and elevation angle noise for a respective standard deviation of σ_{Azimuth}=0.326° and σ_{Elevations}=0.275° with 5000 data points. The azimuth and elevation angle noise is, for example, added to the azimuth and elevation angle of the reference light beam 16 to generate the plurality of auxiliary light beams 18.

FIG. 3c shows a diagram of the azimuth and elevation angle noise from FIG. 3b, wherein 100 data points were randomly selected that are used to calculate the auxiliary light beams 18.

FIG. 4a shows a two-dimensional representation of a virtual light beam cone 22 in the virtual test environment 4 with a first virtual object 24 and a second virtual object 26, wherein a first distance r₁=29.5 m lies between the first virtual object 24 and the starting point 14 and a distance r₂=29.65 m lies between the second virtual object 26 and the starting point 14. The light beam cone 22 comprises the reference light beam 16 and the 100 selected auxiliary light beams 18 that each have different azimuth and/or elevation angles and that start from the same starting point 14. In this respect, a width of the light beam cone 22 defined in this manner is determined by the statistics of the beam profile, i.e. by the azimuth angle and/or elevation angle of the auxiliary light beams.

In accordance with the method described in FIG. 2, the histogram shown in FIG. 4b with a bin size of 7.8 cm is subsequently determined. In FIG. 4b, it can be seen that two bins with an increased number of determined distance values were determined that correspond to points of impact in each case uniquely on the first or second virtual object 24, 26. However, based on the method described in FIG. 2, only the bin with the largest number of determined distance values is considered for the further calculation of the average distance value. In the present case, an average distance value of 29.49 m results that serves as the expected value for the normal distribution. Additionally or alternatively, it is also possible that if the histogram is found to have two or more maxima, a warning signal is output that indicates that a unique distance value could not be determined. A multi-echo situation and/or an edge impact can in particular hereby be recognized.

FIG. 5 illustrates the method for calculating the radial speed of a point of impact of the virtual transmission signal on the virtual object with respect to the virtual sensor or the starting point 4 of the virtual transmission signal. For this purpose, a point of impact of a first virtual light beam within a virtual object 30 defined by a grid is determined at a point in time t=t₀, wherein the exact position of the point of impact is determined with reference to the corners V₁, V₂ and V₃ of the grid. Based on the coordinates of the point of impact in the virtual test environment and the starting point, a position vector vₕᵢₜ^{s}(t₀) is determined.

At a point in time t=t₀+Δt, the current position of the point of impact relative to the virtual sensor vₕᵢₜ^{s}(t₀+Δt) is determined on the basis of the information of the positioning of the point of impact within the grid.

Based on the two position vectors, the velocity vector v of the point of impact of the virtual transmission signal on the virtual object 30 is determined. For example, the velocity vector v is determined by the following equation:

$$v = \frac{{v}_{h i t}^{s} ( {t}_{0} + Δ t ) - {v}_{h i t}^{s} ( {t}_{0} )}{Δ t}$$

The radial speed is subsequently determined by the projection of the velocity vector v onto the position vector vₕᵢₜ^{s}(t₀), as shown in FIG. 5.

FIG. 6 illustrates two different possibilities of processing the data generated by the simulation model. In FIG. 6a, a plurality of virtual light beams detected up to a measurement time t_{M} are processed simultaneously. In this case, one also speaks of a so-called snapshot processing.

FIG. 6b, on the other hand, illustrates a possibility in which a plurality of virtual light beams detected up to the measurement time tm are divided into a predefined number of subsets 28 that each correspond to an equal time duration, wherein the virtual light beams belonging to a subset 28 are jointly processed. In this case, one speaks of a so-called scanning.

### REFERENCE NUMERAL LIST

2 method for modelling a sensor
4 virtual test environment
6 virtual vehicles
8 virtual road signs
10 virtual road markings
12 virtual buildings
14 starting point
16 reference light beam
18 auxiliary light beams
22 light beam cone
24 first virtual object
26 second virtual object
28 subsets
30 virtual object
100-200 method steps

1. A method for modeling a sensor, in particular an FMCW LiDAR sensor for distance measurement, in a virtual test environment, wherein:
a simulation model is defined, wherein the simulation model comprises a virtual sensor and the virtual test environment, wherein in the method (2):
a virtual transmission signal sent by the virtual sensor is simulated in the virtual test environment;
it is determined whether the virtual transmission signal impacts a virtual object at a point of impact in the virtual test environment;
in the event of a positive determination, a distance of the virtual transmission signal covered by the virtual sensor up to the point of impact is calculated in the virtual test environment; and
at least one output value of the virtual sensor is determined based on the calculated distance,
wherein the determination of the output value further takes place based on at least one parameter of the simulation model, wherein the parameter and/or the output value is/are modeled by a probabilistic distribution.

2. The method in accordance with claim 1,
wherein noise is generated in the output value by the probabilistic distribution.

3. The method in accordance with claim 1,
wherein the probabilistic distribution comprises a normal distribution.

4. The method in accordance with claim 1,
wherein the parameter comprises an azimuth angle of the virtual transmission signal and/or an elevation angle of the virtual transmission signal,
wherein the virtual transmission signal is simulated based on the azimuth angle, the elevation angle and a starting point of the virtual transmission signal.

5. The method in accordance with claim 4,
wherein the virtual transmission signal is simulated only based on the azimuth angle, the elevation angle and a starting point of the virtual transmission signal.

6. The method in accordance with claim 4,
wherein the method further comprises that:
the azimuth angle and elevation angle of the virtual transmission signal are modeled as an expected value by a probabilistic distribution with a predefined reference azimuth angle and a predefined reference elevation angle;
a plurality of different virtual auxiliary transmission signals, whose azimuth angle and elevation angle differ from the reference azimuth angle and reference elevation angle, are selected based on the probabilistic distribution of the virtual transmission signal;
for each virtual auxiliary transmission signal, it is determined whether the virtual auxiliary transmission signal impacts the virtual object at the point of impact and/or impacts at least one further virtual object at at least one further point of impact; in the event of a positive determination, a distance of the virtual auxiliary transmission signal covered by the virtual sensor up to the point of impact is calculated in the virtual test environment; and
a final distance value is determined based on the plurality of calculated distance values.

7. The method in accordance with claim 6,
wherein the final distance value is determined in that:
a predefined number of bins of the same size is initialized for a predefined distance range, with each bin being assigned to a different subrange within the predefined distance range;
for each auxiliary transmission signal, it is determined whether the corresponding virtual transmission signal has a respective point of impact with the virtual object and/or the at least one further virtual object in the virtual test environment and in the event of a positive determination, an associated distance value is determined from the starting point to the respective point of impact, wherein each distance value is assigned to a corresponding bin;
an average distance value is calculated based on the distance values that are associated with the bin that has the highest number of assigned distance values;
the final distance value is modeled by means of a probabilistic distribution based on the average distance value and is defined as the output value.

8. The method in accordance with claim 7,
wherein for each auxiliary transmission signal, it is determined whether the the at least one further virtual object in the virtual test environment is in the predefined distance range.

9. The method in accordance with claim 1,
wherein the determination of a radial speed of a point of impact i with respect to the virtual sensor comprises that:
the point of impact i of the virtual transmission signal on the virtual object is determined at a point in time t, wherein the position of the point of impact vₕᵢₜ(t) on the virtual object is determined in the three-dimensional virtual test environment;
at a point in time t+Δt, the current position of the point of impact vₕᵢₜ(t+Δt) on the virtual object is determined in the three-dimensional virtual test environment; and
at a point in time t+Δt, the three-dimensional velocity vector of the point of impact i is determined based on the two temporally consecutive positions of the point of impact vₕᵢₜ(t) and vₕᵢₜ(t+Δt) and, by projection in the direction of the transmitted virtual transmission signal, the radial speed of the point of impact i is determined with respect to the virtual sensor in the virtual test environment at the point in time t.

10. The method in accordance with claim 1,
wherein a validity of the output value is determined based on a distance-dependent probability of recognizing an object.

11. The method in accordance with claim 1,
wherein physical sensor data and/or physical position data of a real sensor are evaluated to create the virtual test environment.

12. The method in accordance with claim 1,
wherein information obtained in the virtual test environment is used to configure a real sensor for real operation.

13. The method in accordance with claim 12,
wherein the output values are used to configure a real sensor for real operation.

14. The method in accordance with claim 1,
wherein annotation data are generated based on data of the virtual test environment and/or data of the virtual sensor.

15. The method in accordance with claim 14,
wherein the annotation data comprises metadata or data on virtual objects in the virtual test environment.

16. The method in accordance with claim 14,
wherein AI models for mobile robots and/or for fork-lift trucks are trained by means of the data generated by the simulation model and/or the annotation data.

17. The method in accordance with claim 1,
wherein a plurality of virtual transmission signals acquired up to a predefined measurement time are processed simultaneously.

18. The method in accordance with claim 1,
wherein a plurality of virtual transmission signals acquired up to a predefined measurement time are divided into a predefined number of subsets that each correspond to an equal time duration, wherein the virtual transmission signals belonging to a subset are processed simultaneously.

19. A system for modeling a sensor in a virtual test environment, said system comprising:
a simulation device that is configured:
to define a simulation model, wherein the simulation model comprises a virtual sensor and the virtual test environment;
to simulate a virtual transmission signal sent by the virtual sensor in the virtual test environment;
to determine whether the virtual transmission signal impacts a virtual object at a point of impact in the virtual test environment;
in the event of a positive determination, to calculate a distance of the virtual transmission signal covered by the virtual sensor up to the point of impact in the virtual test environment; and
to determine at least one output value of the virtual sensor based on the calculated distance,
wherein the determination of the output value further takes place based on at least one parameter of the simulation model, wherein the parameter and/or the output value is/are modeled by a probabilistic distribution.

20. The system of claim 19, wherein the sensor is an FMCW LiDAR sensor.
